(19) United States
(12) Patent Application Publication
(10) Pub. No.: US 2012/0087231 A1
(43) Pub. Date: Apr. 12, 2012

(54) Packet Loss Recovery Method and Device for Voice Over Internet Protocol

(76) Inventors: Huan Qiang Zhang, Beijing (CN); Zhi Gang Zhang, Beijing (CN)

(21) Appl. No.: 12/086,372

(22) PCT Filed: Dec. 1, 2006
(86) PCT No.: PCT/EP2006/069215

§ 371 Date: Jun. 11, 2008

(30) Foreign Application Priority Data
Dec. 15, 2005 (EP) 05301057.5

(51) Int. Cl. H04L 12/26

(52) U.S. Cl. 370/216

(57) ABSTRACT

A method and device for method of doing packet loss recovery in VoIP system is disclosed. By employing the information in LPC parameters of CELP codec, the speech packets/frames which belong to the beginning segment of each speech phoneme are located, and packet repetition is adopted to protect these packets before they are transmitted in the network.

### FIELD OF THE INVENTION

The present invention relates generally to packet loss recovery, and more particularly to method and device for packet loss recovery in a Voice over Internet Protocol (VoIP) system.

### BACKGROUND OF THE INVENTION

The packet loss (including those packets with large delay jitter) will degrade speech quality, and even make the speech incomprehensible. To solve this problem, many schemes have been proposed. These schemes can be classified into sender-based Packet-Loss Recovery (PLR) and receiver-based Packet-Loss Concealment (PLC) [C. Perkins, O. Hodson, and V. Hardman, “A survey of packet-loss recovery techniques for streaming audio,” IEEE Network Magazine, September/October, 1998] . PLR methods include interleaving and other FEC mechanism (like packet-level retransmission, data protection on important codec parameters). PLC methods include: silent substitution, packet repetition, interpolation [ITU-T Recommendation G.711 Appendix I, A high quality low-complexity algorithm for packet loss concealment with G.711, 2000] , time scale modification [Moon-Keun Lee; Sung-Kyo Jung; Hong-Goo Kang; Young-Cheol Park; Dae-Hee Youn; A packet loss concealment algorithm based on time-scale modification for CELP-type speech coders, Proceedings of IEEE International Conference on Acoustics, Speech, and Signal Processing, 2003 (ICASSP '03). Volume 1, 6-10 April 2003 Page(s):I-116-I-119 vol.1] and model-based recovery in CELP codec [ITU-T Recommendation G.729-“Coding of Speech at 8 kbit/s Using Conjugate-Structure Algebraic-Code-Excited Linear-Prediction (CS-ACELP)”, March 1996].

All the PLC mechanisms can improve the perceptual speech quality of VoIP application, and the methods like time scale modification and model-based method have quite good concealment performance. But all these methods perform poor when the burst of packet loss is high. Especially, the problem becomes even worse in WLAN because of packet loss and long latency caused by channel interference and transmission collision when there is heavy traffic load. Therefore, it is desirable to have a solution adopted in large packet loss burst and heavily-loaded networks, which could improve the speech quality while still operates in low bit rate.

### SUMMARY OF THE INVENTION

In one aspect of the present invention, a method for packet loss recovery in a Voice over Internet Protocol (VoIP) system is proposed. The method including the steps of: a) determining a perceptually important voice packet; b) piggybacking the perceptually important voice packet to at least one latter packet; c) transmitting all the packets; and d) reconstructing the packets upon receipt.

According to the present invention, the perceptually important voice packet belongs to a beginning segment of a speech phoneme.

According to the present invention, the perceptually important voice packet is determined in Step a) by employing information in Linear Predictive Coding (LPC) parameters of Code Excited Linear Prediction (CELP) codec.

In another aspect of the present invention, a packet loss recovery device for Voice over Internet Protocol (VoIP) is proposed. The device comprising: a voice capture unit; an encoding unit; a determination unit for determining a perceptually important voice packet; a piggyback unit for piggybacking the perceptually important voice packet to at least one latter packet; a transmitting unit; a receiving unit; a buffering unit for storing the packets and for forwarding the packets to a decoding unit; a decoding unit for reconstructing the packets; and a voice playing unit.

According to the present invention, the determination unit and the piggyback unit could be integrated into the encoding unit.

According to the present invention, the perceptually important voice packet belongs to a beginning segment of a speech phoneme.

According to the present invention, the perceptually important voice packet is determined in Step a) by employing information in Linear Predictive Coding (LPC) parameters of Code Excited Linear Prediction (CELP) codec.

### BRIEF DESCRIPTION OF THE DRAWINGS

FIG. 1 is a diagram showing the waveform of a speech segment for raw data, in the circumstances of no drop, random drop and selective drop;

FIG. 2 shows the Mean Opinion Score (MOS) values of random drop and of selective drop in FIG. 1;

FIG. 3 shows the waveform of English phrase “Hello, world!” and its squared LPC parameter difference D(i);

FIG. 4 shows the squared LPC parameter difference and relation of difference and it average;

FIG. 5 is a schematic diagram showing the re-transmission of important frame;

FIG. 6 is a schematic diagram showing the environment in which the performance of the packet loss recovery mechanism is tested; and

FIG. 7 is a diagram showing the test results for the performance of the packet loss recovery mechanism according to the present invention.

### DETAILED DESCRIPTION OF THE PREFERRED EMBODIMENTS

The technical features of the present invention will be described further with reference to the embodiments. The embodiments are only preferable examples without limiting to the present invention. It will be well understood by the following detail description in conjunction with the accompanying drawings.

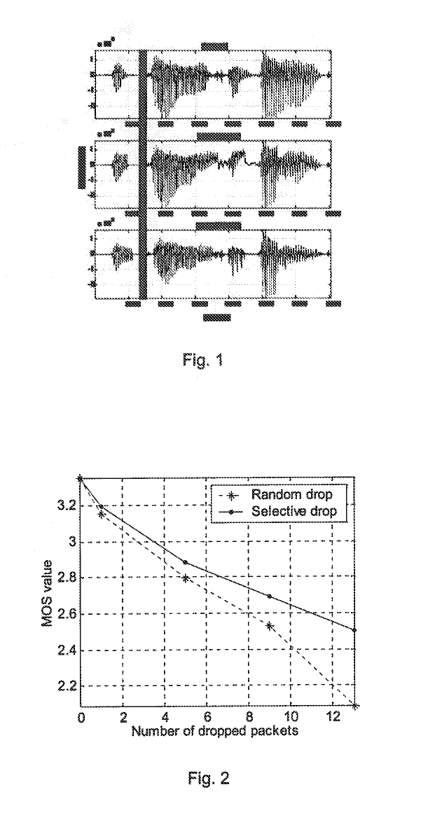

Experiments show that the beginning frames of a speech phoneme are more important than the ones in the middle, because they influence the semantic understanding of a phoneme. And in VoIP application, these frames are even more important, because the Packet Loss Concealment mechanisms in most codec actually constructs lost frames based on the neighbouring non-lost frames, so if the lost packets are those beginning frames of a phoneme, then the whole lost frame of the phoneme beginning part will be constructed base on previous frames, while they are data of another phoneme or even of silence. FIG. 1 shows such an example, where different output waveforms of a CELP codec Speex are shown and these waveforms belong to the following cases:
No Drop: the original speech frames without packet loss;
Random Drop: the speech frames after random packet dropping; and
Selective Drop: the speech frames after dropping those un-important frames (i.e. those frames which are not the beginning part of phonemes), and the loss rate is the same with the case of random drop.

In FIG. 1, the beginning part of a phoneme is marked in grey bar. It can be seen that if this part get lost (the random drop case), the waveform will be substituted by silence.

FIG. 2 gives a quantitative depiction of the concept. It shows the Mean Opinion Scores (MOS) of random drop and selective drop cases. It could be seen from the figure that under the same packet loss rate, the speech quality is better if the beginning frames of phonemes are not dropped.

Most practical low bit rate speech codec like G.723, G.729, GSM, iLBC, Speex etc are based on CELP (Code-Excited Linear Predictive) speech coding algorithm. The basic idea of CELP speech codec is to model the vocal cord and vocal tract with an excitation and a group of filter parameters. The filter parameters are calculated through linear prediction (they are so called Linear Prediction Coding parameters), and then the residuals are coded using an adaptive codebook and a fixed codebook.

In CELP speech codec, the LPC parameters reflect the property of vocal tract. When the shape of the vocal tract changes with each phoneme, the LPC parameters will also changes consequently, and this can be reflected in the squared difference of LPC parameters.

Here we will give a simple description to how to calculate squared difference of LPC parameters. Suppose n-ordered LPC analysis is done in CELP codec, and a₀(i), . . . , aₙ₋₁(i) is the LPC parameter for frame i, then the squared difference of LPC parameters for frame i is calculated as follow:

$$D ( i ) = {\sum }_{k = 0}^{n} {( {a}_{k} ( i ) - {a}_{k} ( i - 1 ) )}^{2} \qquad ( 1 )$$

It's obvious that large D(i) indicates that there's significant LPC parameters variation in current frame compared with the last frame.

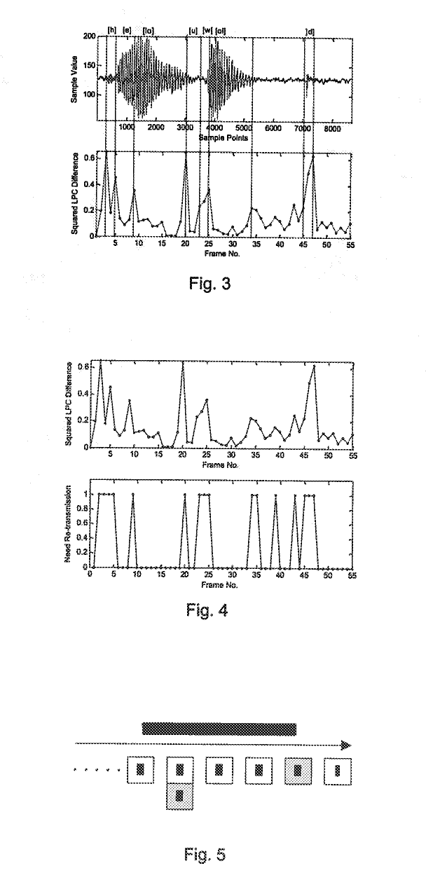

FIG. 3 shows the waveform of English phrase “Hello, world!” and its squared LPC parameter difference D(i). Each phoneme is marked on the upside of waveform figure. We can see that the peaks in D(i) figure (the lower part of the figure) perfectly match the beginning of phonemes.

To locate the beginning frame of all phonemes, we compare D(i) with its average: mean(D(i)) if current D(i) is great than the k*mean(D(i), then frame i is regarded as the beginning part of a phonemes (See FIG. 3), and the frame is attached to a latter frame and therefore will be transmitted twice at least. Here, k is a coefficient around 1, and it need to be finely tuned. If it is too small, it can cause too many frames are taken as phoneme beginning wrongly; and if it is too large, then some frames of phoneme beginning will be unable to spot out. FIG. 4 illustrates an example when k=1.

The way we protect the important speech frames is quite straightforward, just piggybacking the important frames together with later frames as illustrated in FIG. 5, where each block represents an audio frame to be transmitted in the network. The blocks in grey are the important frames to be protected (Here No. 2 frame is the protected frame).

The problem of this approach is that big background noise can cause the difference of LPC parameter change notably, to resolve this problem, silence detection mechanism can be used to enhance the phoneme detection.

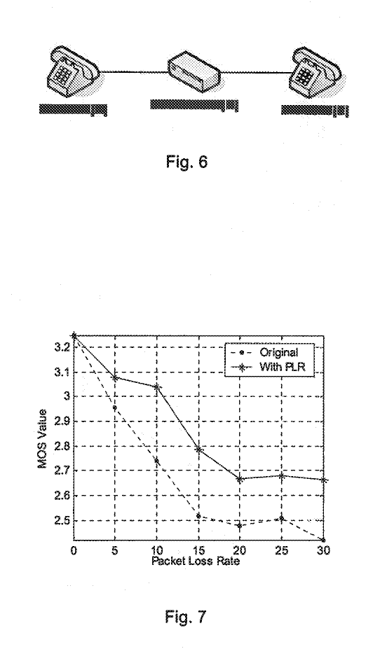

An experiment is done to test the performance of the packet loss recovery mechanism, where two IP phones A and B are connected with each other through a Linux router R, and packet loss is simulated in this Linux router R by running NISTNet (See FIG. 6). In IP Phones, a modified version of open-source speech codec Speex [Speex Codec: http://www.speex.org/] is used, and content-aware PLC is implemented in this codec. A segment of speech data (42 seconds) is transmitted from A to B, where B records the received speech data, and we use PESQ reference software from ITU-T [ITU Recommendation P.862 (02/2001) Perceptual evaluation of speech quality (PESQ), an objective method for end-to-end speech quality assessment of narrow-band telephone networks and speech codecs] to get the MOS quality value of receive speech data. And around 19.2% -30% redundant data are sent to protect the important frames. The experiments results are shown in FIG. 7. It can be seen that there is obvious speech quality improvement by applying packet loss recovery.

The present embodiment is tailored for VoIP applications and especially fits the implementation in Voice over Wireless LAN (VoWLAN), such as present broadband wireless access to Internet through WLAN, WiMAX or 3G networks.

The solution proposed is on one hand computing efficient. Because when determining the beginning of phonemes, the data we use is LPC parameters, which can be get directly from CELP codec. The only extra computation is the calculation of D(i) , if the LPC parameter is n-ordered, then it's n-1 add operations and n multiplications. And to further simplify the computation of D(i), instead of using squared value of LPC parameter differences, we can use the absolute value of the differences.

Moreover, dramatic speech quality improvement is achieved with much less redundancy information retransmission compared with conventional full packet level retransmission. As shown FIG. 7, the retransmission in the present embodiment is only around 30% of the conventional full packet level retransmission.

Whilst there has been described in the forgoing description preferred embodiments and aspects of the present invention, it will be understood by those skilled in the art that many variations in details of design or construction may be made without departing from the present invention. The present invention extends to all features disclosed both individually, and in all possible permutations and combinations.

1. A method for packet loss recovery in a Voice over Internet Protocol (VoIP) system, the method including the steps of:
a) determining a perceptually important voice packet;
b) piggybacking the perceptually important voice packet to at least one latter packet; and
c) transmitting all the packets.

2. The method according to claim 1, wherein said perceptually important voice packet belongs to a beginning segment of a speech phoneme.

3. The method according to claim 1, wherein said perceptually important voice packet is determined in Step a) by employing information in Linear Predictive Coding (LPC) parameters of Code Excited Linear Prediction (CELP) codec.

4. A packet loss recovery device for Voice over Internet Protocol (VoIP), the device including:
a voice capture unit;
an encoding unit;
a determination unit for determining a perceptually important voice packet;
a piggyback unit for piggybacking the perceptually important voice packet to at least one latter packet; and
a transmitting unit for transmitting packets.

5. The device according to claim 4, wherein said determination unit and said piggyback unit are integrated into said encoding unit.

6. The device according to claim 4, wherein said perceptually important voice packet belongs to a beginning segment of a phoneme.

7. The device according to claim 4, wherein the perceptually important voice packet is determined by employing information in Linear Predictive Coding (LPC) parameters of Code Excited Linear Prediction (CELP) codec.

8. The device according to claim 4, wherein the device further comprises
a receiving unit for receiving packets;
a buffering unit for storing the packets and for forwarding the packets to a decoding unit;
a decoding unit for reconstructing the packets; and
a voice playing unit.

9. A method for content-aware packet loss recovery in a VOIP system at receiving side, comprising,
receiving data packets for a phoneme among which data packets belonging to the beginning segment of said phoneme have at least one copy separately in the data packets for said phoneme; and
reconstruct the data packets for said phoneme.

10. The method according to claim 9, wherein the at least one copy of the data packet belonging to the beginning segment of said phoneme is attached to at least one later in time data packet.
